(19) United States
(12) Patent Application Publication
(10) Pub. No.: US 2015/0317593 A1
(43) Pub. Date: Nov. 5, 2015

(54) Task Delegation Assessment with Fatigue-Based Hazard Analysis

(71) Applicants: Cory R. Gudowicz, Dahlgren, VA (US); Javier Villaneuva, Dahlgren, VA (US)

(72) Inventors: Cory R. Gudowicz, Dahlgren, VA (US); Javier Villaneuva, Dahlgren, VA (US)

(73) Assignee: Chief of Naval Research, Office of Counsel, Arlington, VA (US)

(21) Appl. No.: 14/265,523

(22) Filed: Apr. 30, 2014

(51) Int. Cl. G06Q 10/06

(52) U.S. Cl. CPC G06Q 10/063114

(57) ABSTRACT

A fatigue analysis technique is provided for optimizing task scheduling to minimize cumulative fatigue. Fatigue analysis applies to a crew member's task schedule to minimize or mitigate the likelihood of failure during the performance of tasks which may be associated with hazardous events. A fatigue value is associated with each task and the projected amount of fatigue expended by a crew member over the course of a shift may be evaluated in determining whether the performance of some tasks should be prioritized over other tasks. A failure severity level associated with performance of tasks may be used in prioritizing the order of tasks. Thus, the occurrence of potentially catastrophic or critical events due to error caused by human fatigue may be avoided.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to hazard analysis and more specifically to a process for delegating tasks based on analyzing fatigue and hazards that occur because of fatigue in the completion of tasks.

The increase in technology and need to reduce costs has driven engineers to rethink ship designs. A trend in the use of automation to eliminate manual tasks and a reduction in manning can be seen in newer systems. In 2003, the United States General Accounting Office, in a study to evaluate Navy actions needed to optimize ship crew size, indicated the ship's crew is the single largest incurred cost over the ship's life cycle. Although there is a potential cost savings by reducing the ship's crew, a sailor's workload is not necessarily reduced by increased technology. The reduced crew still has to perform periodic maintenance and mission critical tasks on the ship.

The Nuclear Regulatory Commission (NRC), in a study to develop Standardized Plant Analysis models, determined that 62% of all accidents in nuclear power plants are caused by human errors. A February 2009 presentation provided by the Naval Safety Center states that 85% of human errors are caused by fatigue. By increasing the workload on sailors who are already fatigued, human error will likely increase.

Fatigue plays a significant role in human performance, especially in the safe operation of naval vessels, combatant or otherwise. Sailors are constantly being trained physically and mentally to perform their missions successfully in very dangerous and stressful environments. They are required to work as a united workforce to successfully perform many tasks to maintain the operational and mission readiness of the ship. During deployment they might not have any other assistance for long periods of time, so it is essential they know and perform all ship tasks correctly. Errors while deployed at sea could potentially lead to severe injury or even death. When a person is fatigued, they perform in a physically and mentally degraded state. However, the work nonetheless needs to be done to maintain operational availability.

Thus, task delegation may benefit from assigning sequential tasking. The physical and cognitive requirements of the tasks may be considered in an attempt to reduce the likelihood of human error due to fatigue.

### SUMMARY

Conventional hazard analysis yields disadvantages addressed by various exemplary embodiments of the present invention. Accordingly, it is an object of various exemplary embodiments to provide a process for delegating tasks. The process includes identifying tasks to be performed; assigning a fatigue value to each task; prioritizing, via a processing unit, performance of the tasks based on the fatigue value of each task; and outputting, via a processing unit, a schedule of the prioritized performance of the tasks.

Another object of various exemplary embodiments involves optimizing a task schedule. The technique can comprise assigning tasks to be performed in an initial order; calculating, via a processing unit, a fatigue value for the performance of each task; comparing, with the processing unit, the calculated fatigue value to a stored threshold fatigue value for each task; and outputting, via a processing unit, a second order of the tasks so that the calculated fatigue value of each task is below the threshold fatigue value of each task.

Another object of the exemplary embodiments provides a computer program product for delegating tasks to be performed according to a schedule, the computer program product comprising a non-transitory computer readable storage medium having computer readable program code embodied therewith. The computer readable program code may be configured to: identify tasks to be performed; provide an initial schedule of the tasks; assign a fatigue value to each task; identify potentially hazardous events for at least some of the tasks; prioritize, via a processing unit, performance of the tasks based on the fatigue value of each task and the identified potentially hazardous events; and outputting, via a processing unit, a second schedule of the prioritized performance of the tasks.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram of a hazard analysis;

FIG. 2 is a flowchart view of a hazard analysis;

FIG. 3 is a tabular view of a task schedule;

FIG. 4 is a tabular view of a task fatigue analysis.

FIG. 5 is a tabular view of ranked mishap analysis;

FIG. 6 is a tabular view of mishap severity;

FIG. 7 is a tabular view of a chronological schedule;

FIG. 8 is a flowchart of a method of delegating tasks; and

FIG. 9 is a plot comparing an initial task schedule to an optimized task schedule for fatigue allowance per task performed.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a field programmable gate array (FPGA) or other related component.

In general, exemplary embodiments of the present invention may provide the benefit of avoiding or mitigating human error in the performance of scheduled tasks. Fatigue analysis may be applied to a sequential performance of tasks. The results of fatigue analysis may provide the basis for optimizing a schedule for task performance. In an exemplary environment, embodiments of the present invention may be utilized in a naval setting such as a ship or submersible vessel. Crew members may be assigned a schedule of tasks to perform during their shift and the sequence in which those tasks are performed may be optimized to minimize the occurrence of accidents or other events which may result in injury or equipment damage. Fatigue as used throughout this disclosure is defined as weariness or exhaustion from labor, exertion, or stress.

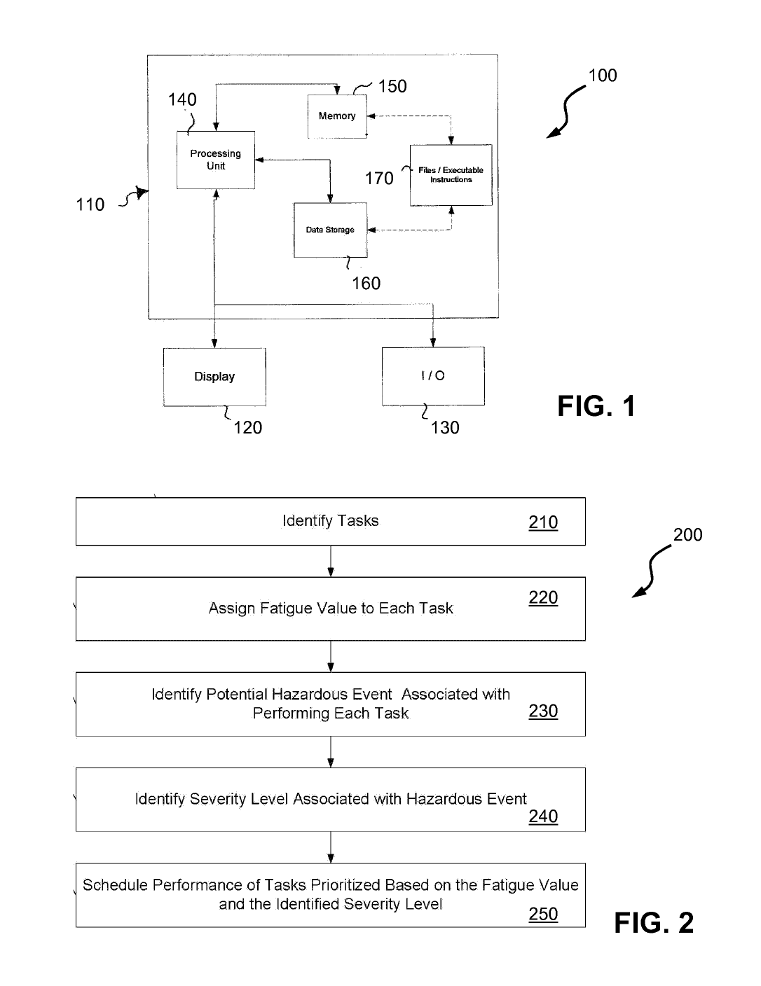

In the drawings, FIG. 1 shows a computing system 100 is shown according to an exemplary embodiment of the present invention. The computing system 100 may be used to receive input (for example, tasks to be performed and assigned to an individual, stored data, etc.) and to provide the fatigue analysis and output of optimized sequence in which the tasks may be performed. The computing system 100 may include a computer 110 connected to a display 120 and an input/output module 130. The computer 110 may be for example, a personal computer, a server, a tablet, a mainframe computer or similar equipment configured to process data. The input/output module 130 may be for example, a keyboard, touch-screen, microphone or other device configured to receive input signals. The computer 110 may include a processing unit 140 connected to a memory module 150 and a data storage module 160. Software files or executable instructions 170 may be stored on either or both the memory module 150 and the data storage module 160.

Exemplary embodiments of the present invention may be in the form of a computer program product. The computer program product may comprise computer readable program code (for example, the software files or executable instructions 170) stored on a non-transitory computer readable storage medium (for example, the memory module 150 and/or the data storage module 160). It will be understood that the activities or steps described below in the blocks associated with flowcharts may be performed by the processing unit 140

Referring now to FIG. 2 showing a flowchart 200 of delegating tasks is shown according to an exemplary embodiment. In block 210, tasks may be identified that need to be completed. The tasks may be a set of duties that need to be done on-board a sea-going vessel. In block 220, a fatigue value may be assigned to the performance of each task. The fatigue value may represent an amount of energy expended by a crew member in performing the task. The fatigue value may be shown as a portion of a total fatigue allowance allowed for a shift. For example, once an individual has expended 100% of their theoretical fatigue allowance, the individual may not have any energy reserves left for basic functions. Thus, a crew member who has used up, for example, 17% of their fatigue allowance is less tired than one who has consumed for example 38% of their fatigue allowance.

In block 230, potential hazard events are associated with performing each task. In block 240, severity of consequences are identified for each hazardous event. In block 250, schedule of task prioritization is created based on fatigue value and identified severity level.

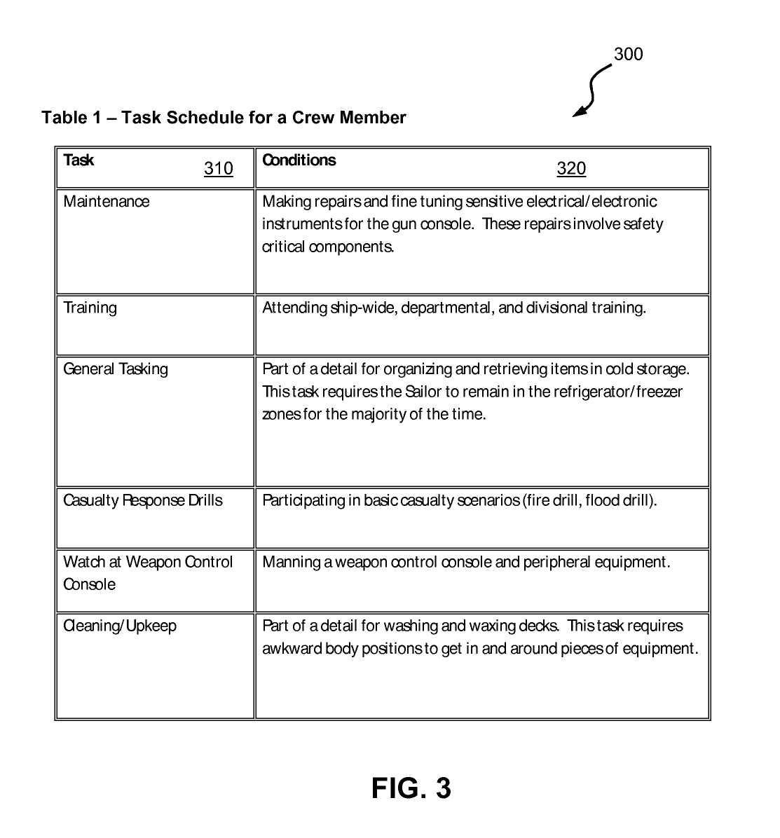

Table 1 shows an example of a list of tasks assigned to a crew member before optimization according to exemplary embodiments. The “Conditions” column describes the expected performance associated with each task. FIG. 3 provides a tabular view 300 of a list of tasks shown in Table 1 to be performed in the order listed. Generally, there may be a time associated with each task and/or an expected duration for completion of the task. The columns include Tasks 310 and Conditions 320.

In evaluating the amount of fatigue a crew member has expended, it may be necessary to account for energy usage throughout the shift for basic light activities such as walking to different stations and basic metabolic functions. For example, a 4% daily allowance of light activities may in some embodiments be assumed to have been exhausted prior to any shift tasks being performed.

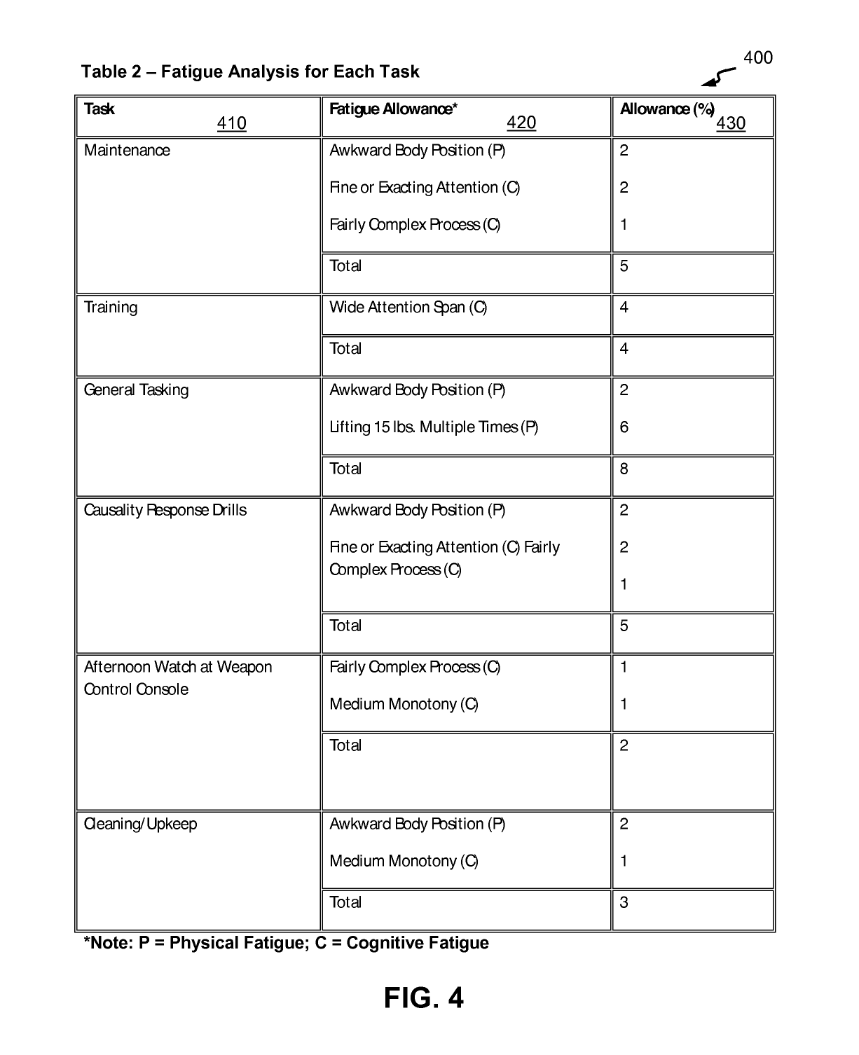

FIG. 4 provides a tabular view 400 in Table 2 that shows an example of fatigue analysis for the tasks assigned in tabular view 300 of Table 1. The columns include Tasks 410, Fatigue Allowance 420 and Allowance percentile 430. In tabular view 400 of Table 2, the “Fatigue Allowance” column 420 provides a description of fatigue types associated with each of the tasks. The “Allowance” column 430 shows the fatigue allowance expenditure per task (shown in percentage of daily fatigue allowance). The fatigue value for each task may be the sum total of fatigue allowance expenditure from the different fatigue types associated with each task.

As shown, some tasks may expend far more fatigue allowance than others. For example, the general tasking assignment may expend approximately 8% of the daily fatigue allowance while the afternoon watch at the weapons console may expend only approximately 2% of the fatigue allowance. Also, one can distinguish between physical fatigue and cognitive fatigue. While both types of fatigue may contribute to expending the overall fatigue allowance, some consideration may be given to whether fatigue is primarily physical or cognitive.

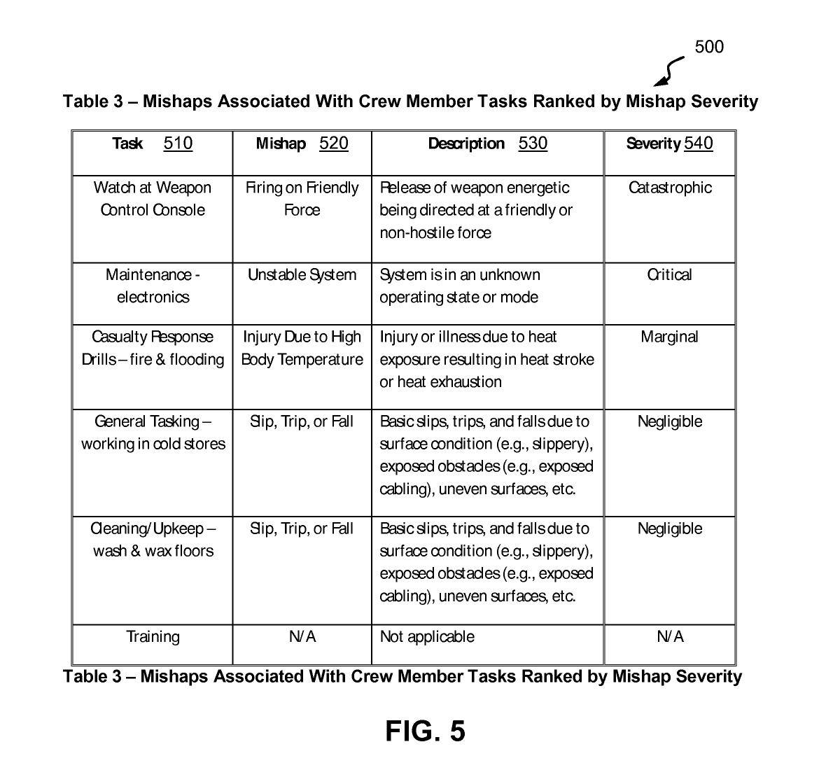

In block 230 of FIG. 2, potential hazardous events associated with performing each task may be identified. FIG. 5 provides a tabular list 500 with Table 3 showing an example of fatigue analysis with potential hazardous events associated with each task. The columns include Tasks 510, Mishap 520, Description 530 and Severity 540. As shown in tabular view 500 of Table 3, the column labeled “Mishap” 520 may define the type of potential hazardous event. The column labeled “Description” 530 may provide a description of the type(s) of hazardous event that may occur as a result of failure due to fatigue.

In block 240, a failure severity level may be associated with the hazardous events. For example, the results of some hazardous effects may cause more damage than others. Referring to tabular view 500 of Table 3, the failure severity level may be categorized as catastrophic, critical, marginal, negligible, or not applicable (listed in descending order of hazard severity) depending on the type of hazardous event associated with a task.

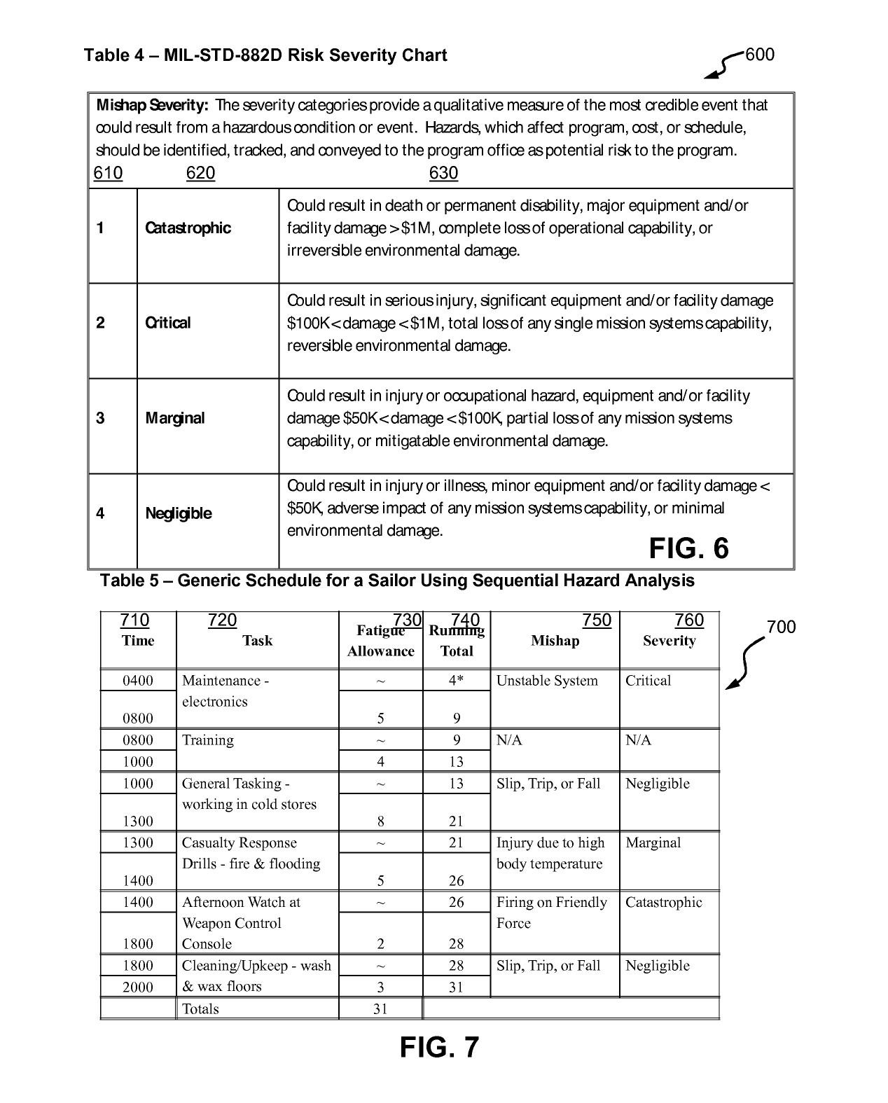

Analysis of the potential hazardous events for severity level may be based on the MIL-STD-882D Risk Severity Chart. This analysis is summarized in FIG. 6 in tabular view 600 as Table 4. The columns include Numerical Category 610, Label 620 and Consequence 630. The category 610 is shown in descending numerical order of severity.

In block 250, the performance of tasks may be prioritized based on the fatigue value. When the fatigue value for a task may result in increased potential for failure, that task may need to be performed earlier in the crew member's shift. In some embodiments, the combination of the fatigue value and the identified failure severity level may be used to prioritize the schedule of tasks.

For example, tasks whose associated failure severity level is catastrophic or critical may be prioritized over tasks of marginal or lesser failure severity level. As may be appreciated, by prioritizing the performance of tasks with higher failure severity levels, the chance of failure due to fatigue when performing those tasks may be lessened because the crew member may be overall less fatigued when performing the task.

FIG. 7 shows an exemplary chronology schedule chart 700 in Table 5 as Generic Schedule for a Crew Member Using Hazard Analysis. The columns include Time 710, Task 720, Fatigue Allownace 730, Running Total 740, Mishap 750 and Severity 760. The running total 740 constitutes accumulated time from a specified beginning to compare fatigue levels.

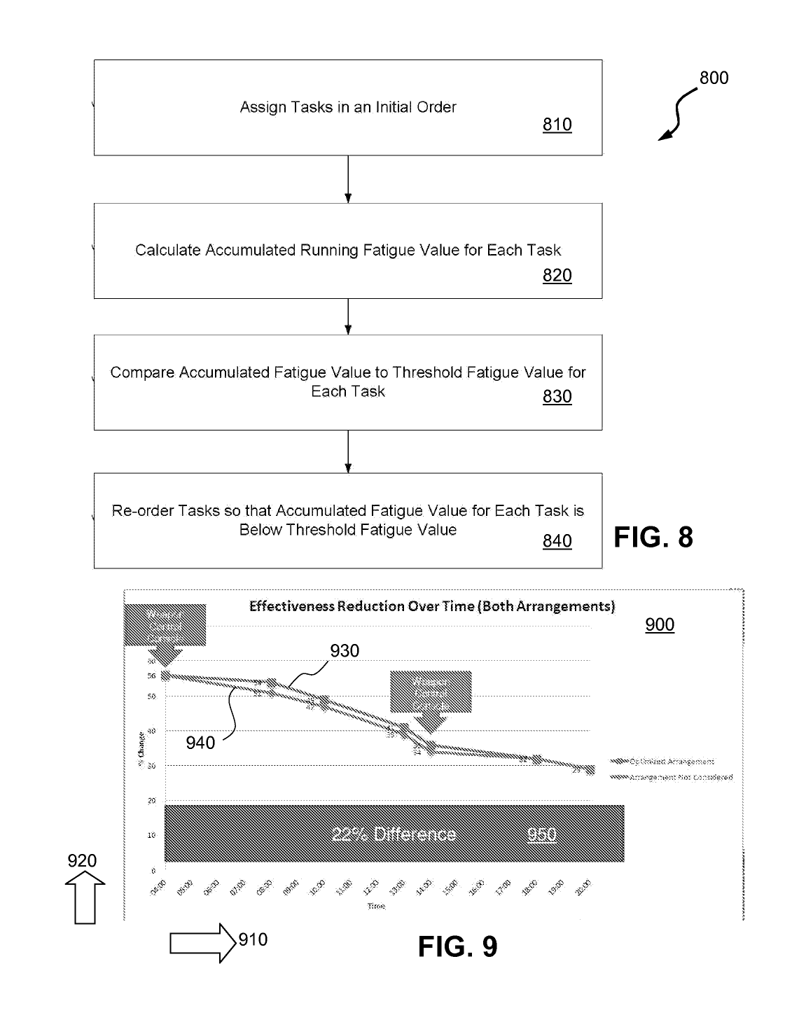

Referring to FIG. 8, a flowchart view 800 of optimizing a task schedule is shown according to an exemplary embodiment of the present invention. In block 810, tasks may be assigned to a crew member and presented in an initial order. In block 820, an accumulated running fatigue value may be calculated for each task if performed in sequence according to the initial order. For example, the tasks in tabular view 700 of Table 5 are presented in the initial order shown in tabular view 300 of Table 1. The fatigue value has been assigned, the hazardous event identified, and the failure severity level identified for each task. The column labeled “Running Total” 740 shows the sum of fatigue allowance expended for each task performed and for the tasks performed prior to each task.

For example, by the time the crew member is scheduled to perform his casualty response drills at 13:00, he or she has already expended a total of 21% accumulated fatigue allowance, which is the sum of 9% from the Maintenance task(s), 4% from the training task, and 8% from the general tasking assignment. The beginning of the running total may not necessarily be from 0% because the crew member may have engaged in other activity before attending to his or her schedule of tasks. In some embodiments, a stored threshold accumulated fatigue value may be associated with some tasks.

In block 830, the accumulated fatigue value may be compared to the threshold fatigue value. If the schedule of tasks results in the accumulated fatigue value of the task exceeding the threshold value, then the task should be moved higher up in priority to lower the resultant accumulated fatigue value. For example, tasks associated with watch over the weapon control system may have a threshold accumulated fatigue value of 20. In the initial order shown as chart view 700 of Table 5, the watch over weapon control systems is scheduled such that the crew member's accumulated fatigue allowance exceeds the threshold value, and one can assume that the chances of the crew member failing at his assigned task are increased.

Thus, in block 840, the tasks may be re-ordered so that the accumulated fatigue value for each task is below the respective threshold values for each task. Referring to tabular view 600 in Table 4, an example re-ordering of the tasks from tabular view 700 is shown as optimized for minimizing performance failure.

The crew member's shift now begins with a watch at the weapons control console and is now followed by maintenance of electronics. As may be appreciated the tasks with the highest failure severity levels are also now prioritized so that their performance is done with the least amount of fatigue allowance expended.

FIG. 9 provides a plot view 900 shown comparing Effectiveness Reduction over time, indicating results of the initial order of tasks to the optimized schedule of tasks. The abscissa 910 denotes elapsed time, and the ordinate 920 represents effectiveness. The upper line 930 denotes optimized arrangements, and the lower line identifies effectiveness without considering such optimization. The effectiveness difference 950 of 22% is shown as a threshold. The optimized schedule of tasks presents an unexpected difference in the amount of effectiveness available to a crew member when performing tasks with higher severity levels. The plot represented by diamonds represents the initial order of tasks that has not undergone fatigue analysis. The plot represented by boxes represents the optimized schedule of tasks according to exemplary embodiments of the present invention.

While some tasks may not require a large fatigue value to perform, the timing and order in which the task is performed may lead to increased likelihood of failure. For example, the watch at the weapons console (which is associated with a catastrophic failure scenario) only requires a fatigue value of 2% of the daily fatigue allowance. In the initial order of tasks, the watch at the weapons console is performed at 14:00 hours when the crew member's fatigue effectiveness is down to 34%. Under the optimized schedule of tasks, the watch at the weapons console is performed at 4:00 hours and the crew member's fatigue effectiveness is still at 56%. Optimization of task scheduling under exemplary embodiments of the present invention thus yields a 22% improved difference in avoiding failure when performing his or her watch at the weapons console.

It will be understood that many additional changes in the details, materials, steps and arrangement of parts, which have been herein described and illustrated in order to explain the nature of the invention, may be made by those skilled in the art within the principle and scope of the invention as expressed in the appended claims.

The foregoing description of the preferred embodiments of the invention has been presented for purposes of illustration and description only. This description is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A method of delegating tasks, comprising:
identifying tasks to be performed;
assigning a fatigue value to each task;
prioritizing, via a processing unit, performance of the tasks based on the fatigue value of each task; and
outputting, via a processing unit, a schedule of the prioritized performance of the tasks.

2. The method of claim 1, further comprising assigning a failure severity level associated with performance of each task, wherein the step of prioritizing is also based on the failure severity level each task.

3. The method of claim 2, further comprising identifying a potentially hazardous event associated with each task, wherein the failure severity level is based on the potentially hazardous event.

4. The method of claim 3, wherein tasks with a higher failure severity level are prioritized ahead of tasks with a lower failure severity level.

5. The method of claim 4, further comprising calculating a running total of accumulated fatigue value for the performance of each task.

6. The method of claim 5, wherein tasks with predetermined failure severity levels are prioritized ahead of tasks with a lower failure severity level in response to the tasks with the predetermined failure severity levels exceeding a threshold accumulated fatigue value.

7. The method of claim 2, wherein tasks with predetermined failure severity levels are prioritized ahead of tasks with a lower failure severity level.

8. A method of optimizing a task schedule, comprising:
assigning tasks to be performed in an initial order;
calculating, via a processing unit, a fatigue value for the performance of each task;
comparing, with the processing unit, the calculated fatigue value to a stored threshold fatigue value for each task; and
outputting, via a processing unit, a second order of the tasks so that the calculated fatigue value of each task is below the threshold fatigue value of each task.

9. The method of claim 8, wherein the calculated fatigue value of each task is a running total of accumulated fatigue.

10. The method of claim 9, further comprising identifying a failure severity level associated with performance of each task, wherein the step of prioritizing is also based on the failure severity level each task.

11. The method of claim 10, wherein tasks with predetermined failure severity levels are prioritized ahead of tasks with a lower failure severity level in response to the tasks with the predetermined failure severity levels exceeding a threshold accumulated fatigue value.

12. The method of claim 11, wherein the predetermined failure severity levels correspond to events that cause death or injury.

13. The method of claim 8, wherein the second order of tasks are output to be performed in sequential order.

14. A computer program product for delegating tasks to be performed according to a schedule, the computer program product comprising a non-transitory computer readable storage medium having computer readable program code embodied therewith, the computer readable program code being configured to:
identify tasks to be performed;
provide an initial schedule of the tasks;
assign a fatigue value to each task;
identify potentially hazardous events for at least some of the tasks;
prioritize, via a processing unit, performance of the tasks based on the fatigue value of each task and the identified potentially hazardous events; and
outputting, via a processing unit, a second schedule of the prioritized performance of the tasks.

15. The computer program product of claim 14, the computer readable program code being configured to calculate a running total of accumulated fatigue for performance of each task according to the initial schedule of tasks.

16. The computer program product of claim 15, wherein tasks in the second schedule are prioritized based on tasks with identified potentially hazardous events exceeding a predetermined total of accumulated fatigue.

17. The computer program product of claim 14, the computer readable program code being configured to assign a failure severity level associated with performance of each task, wherein prioritizing is also based on the failure severity level each task.

18. The computer program product of claim 17, wherein the failure severity level is categorized according to the identified potentially hazardous events for each task.

19. The computer program product of claim 17, wherein tasks with a higher failure severity level are prioritized ahead of tasks with a lower failure severity level.

20. The computer program product of claim 17, wherein the second schedule of the prioritized performance of the tasks are output to be performed in order.
